(19) United States
(12) Patent Application Publication
(10) Pub. No.: US 2010/0185346 A1
(43) Pub. Date: Jul. 22, 2010

(54) AERIAL PAYLOAD DEPLOYMENT METHOD

(76) Inventor: JOHN STEVEN SURMONT, Chula Vista, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/690,840

(22) Filed: Jan. 20, 2010

Related U.S. Application Data
(60) Provisional application No. 61/146,251, filed on Jan. 21, 2009.

(51) Int. Cl. B64B 1/50; G06F 17/00; H04B 7/15; G06F 19/00

(52) U.S. Cl. 701/4; 244/33; 701/3; 455/11.1; 702/41; 702/55

(57) ABSTRACT

The present invention provides a method, comprising: providing an aerial platform having an outer shell; disposing a gas containment system within the outer shell; attaching the aerial platform to an object using a tether system; and inflating the aerial platform and lifting a payload; wherein the aerial platform is configured such that it may be completely collapsed when deployed.

### CROSS-REFERENCE TO RELATED APPLICATIONS

This application claims priority to U.S. Provisional Patent Application Ser. No. 61/146,251 filed Jan. 21, 2009, the content of which is incorporated herein by reference in its entirety.

### TECHNICAL FIELD

The present invention relates to aerial electronics deployment, and more particularly, some embodiments relate to portable aerostat deployment systems.

### DESCRIPTION OF THE RELATED ART

In large metropolitan areas, police departments and other public safety departments frequently use helicopters to fulfill their mobile surveillance needs. Smaller police and public safety departments usually cannot afford the cost of a department specific helicopter. Therefore, departments must frequently share access to a helicopter amongst themselves, or between departments in different cities. Accordingly, it can take hours to deploy a surveillance helicopter. These long delay times can be detrimental to the immediate need for surveillance response to situations like crime scenes, high speed chases and amber alerts.

Alternative systems and devices for surveillance, reconnaissance, tagging and tracking are used to replace high-cost helicopters and surveillance devices, such as deploying an aerostat aerial platform to survey an area of interest, mounting a camera to the wing of a lightweight aircraft, or flying a small unmanned aerial system (UAS). However, these devices and systems often remain cost prohibitive. Additionally, many conventional systems require extended training in use, or require multiple personnel to deploy. These additional costs further prevent their implementation in smaller police or other public safety departments.

### BRIEF SUMMARY OF EMBODIMENTS OF THE INVENTION

According to various embodiments of the invention, a mobile aerial platform system is provided. The system may lift a payload, such as a surveillance system or a communications repeater, into the lower atmosphere to assist in providing command and control functions such as communications, surveillance, crowd control and disaster relief. The portable aerial platform system may be transported to the deployment site using a vehicle.

In one embodiment, a method comprises: providing an aerial platform having an outer shell; disposing a gas containment system within the outer shell; attaching the aerial platform to an object using a tether system; and inflating the aerial platform and lifting a payload; wherein the aerial platform is configured such that it may be completely collapsed when deployed.

In some embodiments, the aerial platform comprises an outer shell that provides an aerodynamic shape to effect desired flight performance characteristics.

According to a further embodiment of the invention, the aerial platform comprises a plurality of gas chambers contained by an aerodynamically shaped outer shell, thereby providing the combination of an aerodynamic lifting body and a lifting gas-filled aerial platform.

In another embodiment, the aerial platform may comprise a plurality of outer shell materials containing helium-filled chambers coupled to and alternating with a plurality of ram-air chambers and having an aerodynamic shape to provide lift. In this embodiment, the ram-air chambers are configured to collapse when the aerial platform is collapsed, wherein the amount of lift provided by the aerodynamic shape is reduced if the aerial platform is at least partially collapsed.

In another embodiment, the aerial platform may comprise a torque stabilization system having upper and lower vertical stabilizers with corresponding vertical stabilizer shroud fixtures along the upper and lower aft section of the outer shell surface of the system to provide for directional stability along the longitudinal axes of the system during flight.

In a further embodiment, the aerial platform may comprise a rapid deflation device to facilitate rapid deflation in the event of line separation. The rapid deflation device is configured as a microcontroller, power circuit, logic circuit and wiring harness directly affixed to the gas bladders in such a way that in the event of line breakage, power is applied to the wiring harness and exposed wires in such a manner as to create vent holes for gas to escape from the gas containment system.

In an additional embodiment, the aerial platform may be configured such that it has an onboard flight control system to enable the system to maintain and achieve a stationary position in no wind, low wind, gusty wind and high wind environments.

In another embodiment, the aerial platform may be configured to have one or more lines attaching the system to a cable or line to provide power to the aerial platform.

In a further embodiment, the aerial platform may have an onboard monitoring system to provide for capturing, receiving, storing and publishing data collected by the aerial platform's onboard sensors, including but not limited to: (i) a horizontal attitude sensor; (i) an altitude sensor; (iii) an external ambient environmental conditions sensor (e.g., for wind speed and direction); (iv) a gas chamber volume sensor; and (v) a tether force or tension sensor.

In yet another embodiment, the aerial platform may include a system and method for transmitting and receiving the captured, stored, retrieved and published data to provide an automated training and support system.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1a-1b depict an example aerial platform in its deployed state, in accordance with an embodiment of the invention.

FIG. 1c depicts another example aerial platform in its deployed state, in accordance with an embodiment of the invention.

FIG. 2a depicts a further example deployed aerial platform in accordance with an embodiment of the invention.

FIGS. 2b depicts a side view of an example deployed aerial platform in accordance with an embodiment of the invention.

FIGS. 2c depicts a front view of an example deployed aerial platform in accordance with an embodiment of the invention.

FIG. 2d depicts a top down view of an example deployed aerial platform in accordance with an embodiment of the invention.

FIG. 3a illustrates a top down view of an alternative embodiment employing a collapsible aerial platform, in an uncollapsed state.

FIG. 3b illustrates a top down view of an alternative embodiment employing a collapsible aerial platform, in a collapsed state.

FIG. 4 depicts a functional block diagram illustrating an exemplary payload, in accordance with an embodiment of the invention.

FIG. 5 depicts an example non-deployed aerial platform system disposed in the back of a vehicle, in accordance with an embodiment of the invention.

FIG. 6 depicts a non-deployed aerial platform system, illustrating an example placement of an inflation system, in accordance with an embodiment of the invention.

FIG. 7 depicts an example inflation system, in accordance with an embodiment of the invention.

FIG. 8 depicts an example computing module which may be used to implement various features, in accordance with an embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Before describing the invention in detail, it is useful to describe a few example environments with which the invention can be implemented.

First responders rely on a variety of information gathering, surveillance, and communication tools to obtain and deliver critical life saving information to help those in need. Most of these tools require sophisticated and costly infrastructure. During disasters, infrastructure is frequently destroyed or damaged, leading to critical life safety failures when people need help the most. While terrorism and other nefarious acts remain a threat to communities, natural disasters still cause the most damage to public and private property. By way of example, tornados twist massive towers, floods wash away roads and structures, ice storms interrupt power for days and make roads impassable thereby hindering life safety activities. In addition, hurricanes shut down industries critical to local economies while destroying property, while earthquakes, wildfires, and hurricanes force populations to relocate. Disasters threaten every community. Whether providing communications, surveillance, or information gathering, altitude is essential to providing first responders and others the desired coverage and footprint.

Helicopters and fixed wing aircraft are too expensive for most small communities. Fixed structures (e.g., towers and tall structures) may be ideal for communications, but seldom meet the needs of limited surveillance or information gathering tools. Local government wants to provide the best infrastructure for their public safety personnel and their community, but financial realities force planners and leaders to make tough choices. Limited funds and aging infrastructure make it difficult to meet every need. Most solutions for rural communities are prohibitively expensive. Surveillance and information gathering platforms are usually expensive and require specialized maintenance and operators, thus increasing cost and complexity.

Small communities and counties with limited budgets face difficult decisions that may leave their citizens without an airborne platform capable of supporting public safety tasking. Communities are vulnerable to the damaging effects of terrorism, violent weather conditions, arson, and accidents that damage communication systems and make emergency response more dangerous and uncertain. Incident response to 9-11, the L.A. riots, the Columbine and Virginia Tech shootings, and Hurricane Katrina are examples where compromised communications hindered life saving activities. In all cases, a localized, easily deployable platform could have helped first responders establish and maintain communications when critical infrastructure failed. More importantly, an affordable airborne platform capable of supporting a variety of payloads and missions would give first responders in rural communities and remote areas the infrastructure necessary to extend existing life safety and life saving capabilities to their citizens.

Public Safety organizations and personnel in rural areas often feel forgotten, left out, and unappreciated by regional, state, or federal agencies. Most major equipment purchased or leased is refurbished or used. If such rural areas desire modern communications capabilities, they have to pay for access to a regional, statewide, or an adjoining urban area's communication system. While standards based communications should provide greater coverage and interoperability, they often fail because system administrators or operators fail to grant access to shared interoperable talk groups and the systems were designed to provide coverage to geographic areas containing high population densities.

Alternatives include paying fees to operate on a pubic utility's communications system, thereby taking the community further outside normal public safety operating frequencies. Communication systems are difficult to pay for, making it necessary for communities to get by with existing systems. Some system administrators routinely check eBay to locate used radio equipment so they have spares to keep their systems running. While communications are a critical infrastructure item, the ability to provide surveillance and information gathering to first responders is also critical. Small airfields and the cost of operating fixed or rotary wing aircraft is large.

Finding a platform capable of carrying desired payloads is a time consuming and expensive process. These systems are expensive because most air platforms and associated payloads were designed for the military market or commercial air market, and must therefore meet stringent regulatory standards. The technologies are often highly specialized, if not exotic. Payloads are developed to operate in combat environments and usually have a narrowly predefined set of criteria, limiting their application for public safety.

Disaster response requires the ability to do everything, usually within hours of an incident. Expensive platforms designed for combat are usually very complex and require a large support staff and logistics train, and time to set up. Government typically seeks to put money “where it will do the most good . . . ” This means several things, but for rural communities, it means that grants and other government spending goes toward the largest populations, while rural areas are usually left to fend for themselves. While rural areas could wait for outside support from FEMA and similar state agencies, most strive to prepare themselves to meet their needs. They work closely with vendors, local industry, and non-government organizations to meet response and recovery needs. An affordable platform capable of performing a variety of missions is a tool rural communities can use to meet the life safety needs of their citizens.

The following scenarios are based on common incidents, possible incident response, and incident recovery.

Person Lost in Remote or Wilderness Area

Even the best communications infrastructure has limitations when operating in the vicinity of canyons, valleys, or other terrain features. Under these circumstances, volunteers are called out and air platforms are requested to begin the search. Working dogs may be brought in to find and follow a scent trail. More agencies and people arrive to help search, but the lack of communications coverage creates problems for incident commanders and responders. In some cases, obtaining air assets to aid in the search takes time, increasing the search area. Air search capabilities may also be limited by lack of communications coverage and terrain.

Tornadoes or Other High Wind Events

During a tornado, tornado warning sirens sound, emergency alert messages are transmitted via radio and television, people take cover. Then the tornado rips through a field, mobile home park, or small city with devastating results. Communication towers are destroyed, power is cut off, and access is hindered by debris. Incident commanders have difficulty requesting and coordinating the necessary assets needed to assure live and safety. First responders arrive and begin life saving activities.

According to an embodiment of the invention, a tethered airborne platform can be used to provide surveillance or information gathering capabilities without causing damaged structures to collapse or making it difficult to hear survivors calling for help. Depending on altitude and visibility, the surveillance capabilities could improve the ability to discover casualties and direct life saving efforts to the affected locations. If needed, the platform could provide communications repeater and gateway services. During recovery phases, public works and insurance adjustors could use information gathering capabilities, and combine the data with graphic information systems data to support their recovery efforts.

Large Earthquake Occurs Near a Populated Area

Whether a rural community, small town, or urban center, earthquakes create catastrophic situations. Infrastructure (e.g., electric power, gas lines, water lines, sewage systems, telecommunications, etc.) is damaged or destroyed. Access for local responders is limited by debris in streets. Communications may be limited to line of sight radio systems and shared channels. Access to the incident may be limited by the inability of responders to coordinate with outside resources or blocked and damaged roads. Participation of air assets with surveillance and information gathering capabilities is limited because the noise they create may cause further structural collapse, endangering responders. Access for local responders may be limited by debris in streets. As first responders begin to establish incident, unified, or area commands, they will know whether communications have been adversely affected.

According to an embodiment of the invention, a tethered lighter than air platform could be pulled out of an SUV, truck, or other pre-deployment location to fill any communications gaps. If communications infrastructure is not the an issue, various surveillance payloads could be placed on the platform and deployed to assist in identifying clear response routes, broken gas, water, or sewage lines, and fires. All of this information can be used to help direct the necessary actions. As response becomes recovery, lighter than air platforms could be used to help provide essential communication clouds to refugee areas and the various organizations that are helping with recovery.

Floods or Tsunamis Destroy Property and Infrastructure

Floods occur seasonally due to snow and ice melt. High levels of rainfall occur as various weather systems move through a region or linger in areas that seldom see large volumes of precipitation. In some parts of the country, high tides, storm surges, or pump failures also contribute to flooding. During a flood or tsunami, communication towers that have backup power fail because the generators were connected to gas pipelines (turned off by the gas company) instead of tanks. Towers are built in flood prone areas, causing loss of the transmitters, receivers, amplifiers, and other equipment necessary to provide communications. Emergency operations centers are destroyed or compromised, disabling the response and recovery tools people planned on using. Roads and other infrastructure are destroyed, making access to the devastated area time consuming and difficult. People are forced to relocate, often to areas without communications infrastructure, making it difficult for response agencies (government and non-government) to provide coordinated, efficient, and effective refugee support. Infrastructure (e.g., power and communications) needed by local industry may be destroyed, making it difficult for prepared companies and facilities to restart the jobs that provide devastated employees a variety of reasons to stay and participate in the response and recovery.

Prior to disaster, a tethered air platform of the invention with a ranging system, GPS, and communications link may be employed to monitor water levels in areas not accessible during inclement weather or extreme conditions. With an imaging payload, damaged or breaking dikes, dams, or levees can be detected in near real-time. After the disaster, the same platform can be used to gather information about the damage and resulting situations that need to be addressed or plug gaps caused by a compromised communications infrastructure. The lighter than air platforms of the invention can be used to help provide essential communication clouds to refugee areas and the various organizations that are helping with recovery.

Ice Storms and Other Severe Weather Conditions Disrupt Communications

During severe weather events such as ice storms, the power may go out and communications may be severed. Service providers and emergency responders do not know the extent or severity of the situation and cannot access the region to provide support. Communities want to take care of their own, but emergency managers and leaders may be unable to coordinate an effective response due to the lack of critical infrastructure.

Under such circumstances, a deployable, tethered airborne platform, such as described herein, may be employed to fill gaps in existing or damaged communications infrastructure.

Wildfires Prompt Evacuations and Disrupt Regional Communications

During wildfires, emergency managers may direct evacuees to stadiums, fair grounds, schools, and other preplanned evacuation sights that are hopefully out of harm's way. In the process, facilities and capabilities are overwhelmed. Medical, pharmaceutical, and veterinary care is often needed to meet basic, but critical, life safety needs. Telecommunication infrastructure may be limited due to the increased demand or because infrastructure was damaged or destroyed in the fire. People, trying to stay informed or trying to find or notify relatives, overwhelm infrastructure designed to support a population with limited communication needs. Failures in the communications system have the potential to negatively impact life safety of the refugees. During recovery phases, temporary infrastructure may be needed to facilitate communications, information gathering, surveillance, and coordination.

According to an embodiment of the invention, the lighter than air platforms can be used to help provide essential communication clouds to refugee areas and the various organizations that are helping with recovery. During recovery phases, the surveillance and information gathering capabilities could be used to monitor burnt areas for mudslides, support infrastructure recovery, and fill communication gaps.

Release of Chemical or Biological Hazards

Whether accidental or intentional, natural or manmade, response to these hazards often requires expensive equipment and complex computer modeling to provide basic response information to emergency managers and response personnel. Most small communities cannot afford this equipment, making analysis and response difficult.

According to an embodiment of the invention, a lighter than air platform with a payload capable of measuring the chemical or biological hazard, or even radiation levels, could be used to provide low cost plume monitoring. Depending on payload size, instruments to measure wind, temperature, etc., could be used to gather data to update various plume models when such equipment is not deployed or available in the area.

Person Lost in Remote or Wilderness Areas

Even the best communications infrastructure has limitations when operating in the vicinity of canyons, valleys, or other terrain features. As incident command is established, the lack of communications is discovered.

According to an embodiment of the invention, a tethered air platform with a lightweight communications gateway or repeater can be raised to an altitude of 500 feet, providing responders from various agencies the capability to communicate throughout the search area. Depending on weight constraints, a camera and streaming video equipment could be an added or alternative payload, allowing searchers to identify potential search areas. In some cases, the platform could provide a link to the existing communications system, allowing coordination of additional incident response assets.

In view of the above-described scenarios, the affordable airborne platform embodiments set forth herein have been developed to provide low operating costs and to provide first responders the flexibility to use a variety of payloads designed to meet their needs. This airborne platform is easily transported, is lightweight, requires little maintenance, deploys rapidly with trained or untrained personnel, and flies at altitudes high enough to meet communications, surveillance, and information gathering needs.

The affordable aerial platform can be deployed in 30 minutes or less, can carry a 5-15-pound payload at an altitude of 150±500 feet above ground level for a period of 24 hours or more, and is configured to carry a variety of payloads. Such payloads include, but are not limited to: (i) communications repeaters or gateways; (ii) cameras and other imaging devices; (iii) Wi-Fi or WiMax access points; (iv) cellular amplifiers; and (v) various combinations of these payloads, limited only by weight and power constraints.

The need for communications during the first hour of emergency response is a matter of life and death. While meeting the demand for an affordable lightweight platform capable of filling communication gaps is impressive, additional cross-discipline opportunities make it a tool every public safety agency and private industry should consider. The tethered lighter than air platform may be used for various functions, including but not limited to: (i) accident investigation; (ii) aerial photography; (iii) aerial surveillance; (iv) communications relay and repeaters; (v) construction site monitoring; (vi) crowd control; (vii) first responder events; (viii) land planning and development; (ix) roof inspections; (x) search and rescue; and (xi) traffic management.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

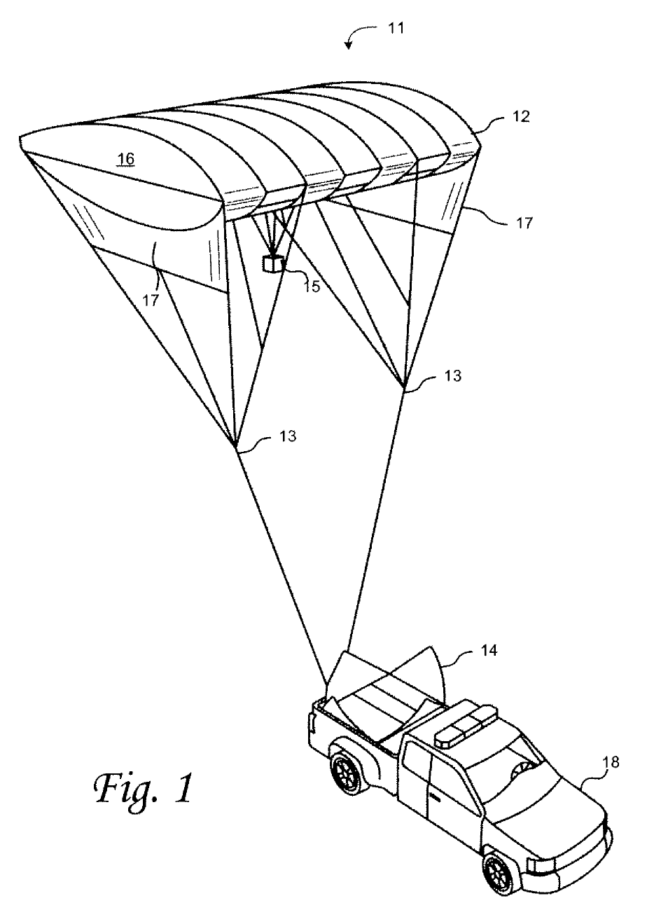

FIGS. 1a-1b depict an example aerial platform in its deployed state. In the illustrated example, mobile aerial platform 1 comprises a lifting/outer shell 2, a gas containment system such as gas bladder inserts 3a-3d, bridle lines 4a-4d, a tether 5, a rapid deflation device 6, a payload 8, and a means for transporting the system such as a vehicle (not shown). The aerial platform 1 further comprises a torque stabilization system comprising a top rudder stabilization shroud 7a, a bottom rudder stabilization shroud 7b, a top vertical stabilizer 7c, and a bottom vertical stabilizer 7d. As illustrated, the torque stabilization system is disposed along the aft section of the outer shell surface of the aerial platform 1 to provide directional stability along the longitudinal axes of the aerial platform 1 during flight.

With further reference to FIGS. 1a-1b, the outer shell 2 of aerial platform 1 provides an aerodynamic shape to effect desired flight performance characteristics. In particular, the gas containment system comprises a plurality of gas bladders 3a-3d contained by the aerodynamically shaped outer shell 2, thereby providing the combination of an aerodynamic lifting body and a lifting gas-filled aerial platform 1. The aerial platform 1 is configured to have one or more bridle lines 4a-4d attaching the aerial platform 1 to tether 5, which attaches to a system power supply. Specifically, the tether 5 and one or more bridle lines 4a-4d may include cables for transmitting power to the aerial platform 1 from the system power supply. Alternatively, the tether and one or more bridle lines may be composed of electrically conductive materials to provide power to the aerial platform system.

In some embodiments, the aerial platform 1 features a rapid deflation device 6 to facilitate rapid deflation in the event of line separation. The rapid deflation device 6 may comprise a microcontroller, power circuit, logic circuit and wiring harness directly affixed to the gas bladders 3a-3d such that, in the event of line breakage, power is applied to the wiring harness and exposed wires to create vent holes in the gas bladders 3a-3d for gas to rapidly escape from the gas containment system.

The aerial platform may be configured such that it has an onboard flight control system to enable the system to maintain and achieve a stationary position in no wind, low wind, gusty wind and high wind environments. Additionally, the aerial platform 1 may have an onboard monitoring system to provide for capturing, receiving, storing and publishing data collected by the aerial platform's onboard sensors. These sensors may include, but are not limited to: (i) a horizontal attitude sensor; (i) an altitude sensor; (iii) an external ambient environmental conditions sensor (e.g., for wind speed and direction); (iv) a gas chamber volume sensor; and (v) a tether force or tension sensor. In some embodiments, the aerial platform 1 may include a system and method for transmitting and receiving the captured, stored, retrieved and published data to provide an automated training and support system.

The onboard monitoring system permits unattended and remote monitoring of the aerial platform 1. In addition, this system allows for communications and surveillance, both mobile-to-mobile and mobile-to-command. Moreover, the onboard monitoring system allows system users to leverage commercial infrastructure, and enables real-time information collection and sharing in the field.

FIG. 1c depicts another example aerial platform in its deployed state. In the illustrated example, mobile aerial platform 11 comprises a lifting shell 12, a payload 15, a tether 13, and a means for transporting the system such as vehicle 18. As illustrated, lifting shell 12 may be coupled to tether 13 using panels 17, loops, or other fixtures. A plurality of fixtures such as loops may be attached to panels 17 of the aerial platform 11 such that the lower edge of surface contour 16 is joined to the upper edge of panels 17, along the entire upper edge. As illustrated, payload 15 may be suspended from the bottom surface of aerial platform 11.

The mobile aerial platforms 1 and 11 of FIGS. 1a-1c may further include a deployment apparatus 14 disposed in various locations such as the back of a vehicle 18. The system may be configured to open to allow egress of the aerial platform 1 or 11 during deployment. The tether 5 or 13 may be attached directly to the vehicle 18, or in some examples, may be attached to other objects such as light posts, fire hydrants, wheel axles, or other objects capable of withstanding the requisite force from the elevated aerial platform 1 or 11. In some embodiments, the tether 5 or 13 is attached via a winch system and/or other load bearing mechanical structures.

The payload 8, 15 of FIGS. 1a-1c may include a single payload or a plurality of payloads comprising a variety of articles or devices depending on the intended application. For example, the payload 8, 15 may carry a communication repeater such as a digital or analog signal repeater for use in an emergency where local communications have been impaired. In another example, the payload 8, 15 may carry surveillance equipment for use in police emergencies such as car chases, crime scene investigations, and amber alerts. In some examples, a general purpose payload that is appropriate for a wide variety of uses may be used. In other examples, weight considerations may constrict the number of different applications for a single payload. In these examples, deployment apparatus 14 may contain receptacles for holding a variety of different application-specific payloads. In these examples, an application-specific payload may be chosen and attached to the system before deployment.

The tether 5, 13 and bridle lines 4a-4d of FIGS. 1a-1c may be composed of electrically conductive materials to provide power to the onboard aerial platform system. In addition, the tether 5, 13 and bridle lines 4a-4d may comprise a material chosen to allow for high altitude deployment. However, because the weight of the tether must be supported by the aerial platform 1, 11, the tether material may be chosen to be as lightweight as possible. In a particular example, an ultra high molecular weight polyethylene such as a Spectra® line (as produced by Honeywell International, Inc.) having a polyester or Kevlar® sleeve or outer protective covering, may be used. In this example, the high strength to weight ratio of the Spectra® line may allow a high altitude deployment without substantially adding to the total weight of the aerial platform. Furthermore, the minimal elastic properties of the line may aid in aerial platform stability during deployment and may further aid in payload position determination. In a particular example, tethers 5, 13 and bridle lines 4a-4d comprise approximately 1000′ of Spectra® line, allowing the aerial platform to reach a height of approximately 500′. In further examples, tethers 5, 13 and bridle lines 4a-4d may further comprise a power cord to supply the payload with power from a generator, battery, or outside line, as needed. Such a power cord may be attached to and run along the tether 5, 13 and one or more bridle lines 4a-4d, or may be formed integral with one of the tethers. In a particular embodiment, tethers 5, 13 and bridle lines 4a-4d may be initially disposed in bags such embodiment, the tether bag may be exchanged for a new bag after the aerial platform is retrieved and before the next deployment.

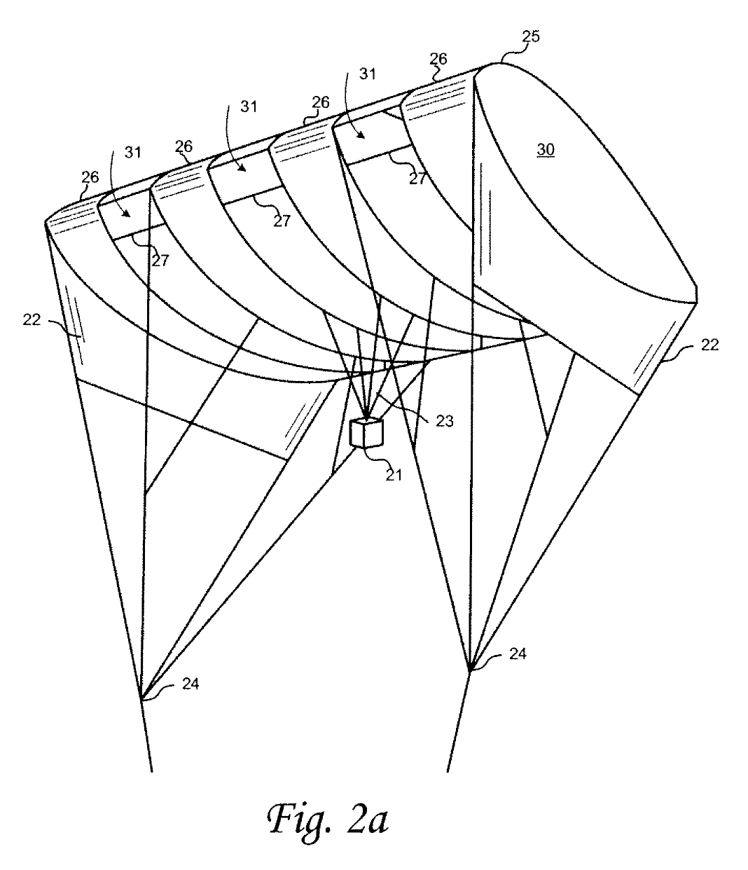

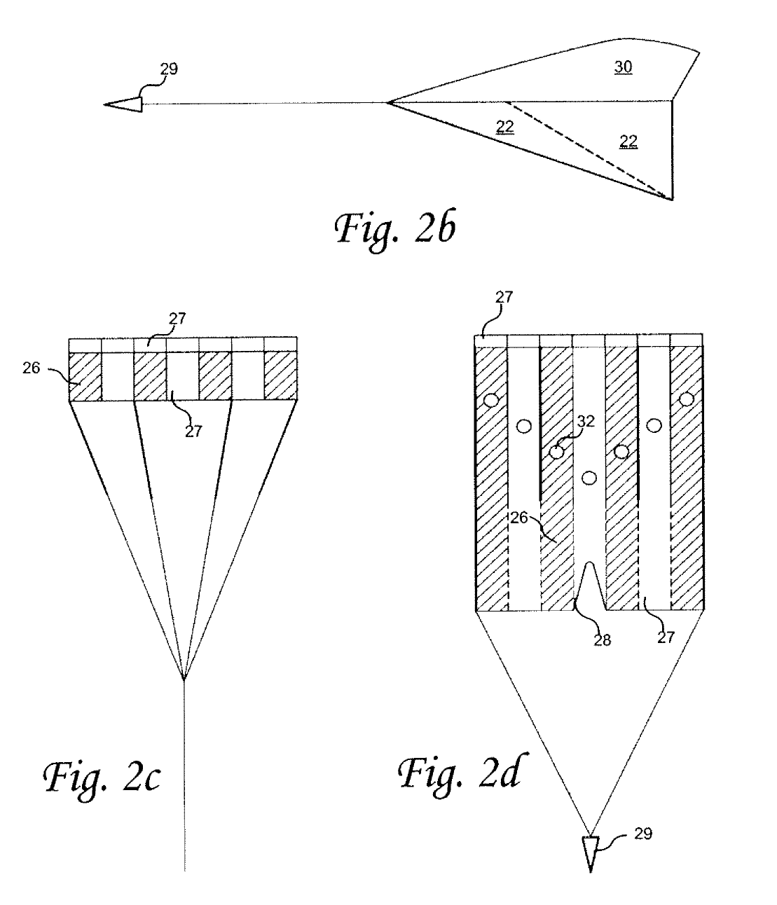

FIGS. 2a-2d depict a further example deployed aerial platform 25 in accordance with an embodiment of the invention. In some embodiments, aerial platform 25 may have a shell comprised of a lightweight plastic such as a biaxially-oriented polyethylene terephthalate polyester film such as Dupont Teijin Films' Mylar®. This shell may be formed so that aerial platform 25 forms an airfoil shape as illustrated by cross sectional contour 30. In addition, the shell may be formed so that stabilizing fixtures and apparatus can be attached in order to provide torque stability control, including connection and attachment points for flight control inputs effecting control surface inputs. This airfoil contour 30 along with affixed torque stability control structures may provide control and stability in windy conditions. The countering forces provided by the torque stability control system in wind along with the airfoil shape 30 may allow the aerial platform 25 to be effectively and safely employed in high wind conditions. Moreover, the shape 30 may provide the aerial platform 25 with connection points and control surfaces, thus allowing the aerial platform 25 to remain operable in high wind conditions. The shape, width, length, and height of the aerial platform 25 may be chosen according to the desired use, payload weight and available helium for inflation. A particular example has a width of 12′, a length of 12′, and a height of 2.5°.

The aerial platform 25 may be shaped like a wing divided into helium cells 26 with a torque stability system. In some examples, helium cells 26 are further comprised of a gas tight material within a plastic shell. For example, helium cells 26 may comprise a polyurethane bladder disposed within the plastic shell. In these embodiments, the bladder may prevent helium leakage. In a particular embodiment, aluminization of polyurethane bladders combines with Mylar® material may provide for the maintenance of a low leakage rate of approximately 1% helium per day. In further embodiments, other materials such as Mylar® may be used instead of polyurethane to contain the helium, so that the aerial platform's weight is further reduced. In some embodiments, ram-air cells 27 are provided in an alternating arrangement with the helium cells 26. In conditions with high ambient temperature, helium leakage may approach 15% per day. In these embodiments, helium fill tube fixtures may be affixed or integrated within the tether system and may be configured to provide additional gas transmission, thus maintaining the shape of the aerial platform 25 in spite of helium leakage or atmospheric conditions.

In a particular embodiment, the aerial platform 25 is configured with a single central ram air cell 27 with two peripheral helium cells 26 on each side of the ram air cell. In the illustrated example, aerial platform 25 has an airfoil shaped cross sectional contour 30 to allow the aerial platform to accommodate a heavier payload in windy conditions. In such an example, the ram-air cells 27 may further provide a greater wing surface area without requiring additional helium gas volume. The illustrated hybrid aerial platform—airfoil shape may also provide stability in windy conditions.

In other embodiments, a plurality of ram-air cells 27 may be disposed above the alternating ram-air and helium cells, as illustrated in FIG. 2c. In these embodiments, the upper ram-air cells 27 may serve to provide additional structural support to the deployed aerial platform. In further embodiments, a plurality of air vents 32 may be disposed in the upper layer of ram-air cells, for example, in the configuration illustrated in FIG. 2d. In still further embodiments, an air vent 28 may be disposed at the rear of the aerial platform. In other embodiments, a stability drogue 29 may be coupled to the rear of the aerial platform. In further embodiments, stability drogue 29 may be detachable, and the system user may attach stability drogue 29 if wind conditions warrant the extra stability.

In some embodiments, the aerial platform may be configured such that it may be deployed without ram-air cells. For example, ram cells may be configured such that they are filled with additional helium gas bladders. In further embodiments, helium cells 26 may be configured such that they may be fully or partially inflated. When partially inflated, the helium cell bladders will not be fully expanded, so spaces will exist between the shells and the bladders. These spaces may serve as further ram-air cells, allowing the aerial platform to gain more lift without the use of additional helium. For example, the system may be configured such that deployment may be performed by inflating the helium cell bladder only to the degree necessary to supplement the lift provided by the ram-air cells.

Aerial platform 25 may be coupled to tethers 24 using panels 22. Panels 22 may comprise the same material as aerial platform 25, for example Mylar®. In other examples, panels 22 may be composed of a material designed to withstand stresses, such as stresses from windy conditions. To prevent wind damage, panels 22 may be composed of a high strength to weight material, such as an ultra high molecular weight polyethylene. Panels 22 may have an upper edge configured to conform to the bottom edge line of the surface contour 30. Panels 22 may be attached to the bottom edge of the aerial platform 25, for example using ultrasonic welding techniques. Systems using panels 22 distribute point forces generated by the attachment of tethers 24 around the entire edge of the aerial platform 25. This attachment may serve to prevent the deformation of the airfoil shape due to stresses caused by the tether in turbulent conditions. In other examples, additional panels 22 may be utilized. For very high wind conditions, a panel 22 may be added along each seam between a ram-air cell 27 and a helium cell 26. Panels 22 may also serve to stabilize the aerial platform 25 while deployed. For example, in some instances panels 22 may be aerodynamically shaped to translate lateral force from cross winds into a forward force along the tether. Such a shaping may allow the aerial platform to have increased stability in rough or high wind conditions. In further examples, the aerial platform body 25 may further comprise flaps, ailerons, rudders, or other control surfaces that can be controlled from the ground or by the payload to further assist in aerial platform stabilization.

In the illustrated configuration, payload 21 is suspended from the bottom of aerial platform 25 using attachment tethers 23. In some examples, attachment tethers 23 may be composed of the same material as tethers 24. In other examples, the attachment tethers 23 do not need to withstand the same forces as the tethers 24 and may be comprised of a less expensive material, e.g., a polymer such as nylon. To further aid in payload stability, attachment tethers 23 may attach to the bottom of the aerial platform 25 at points above, behind, and to each side of the center of mass of payload 21. In further examples, attachment tethers 23 may comprise rigid elements, such as polycarbonate rods. In other examples, attachment tethers may be omitted and payload 21 may be affixed directly to aerial platform 25.

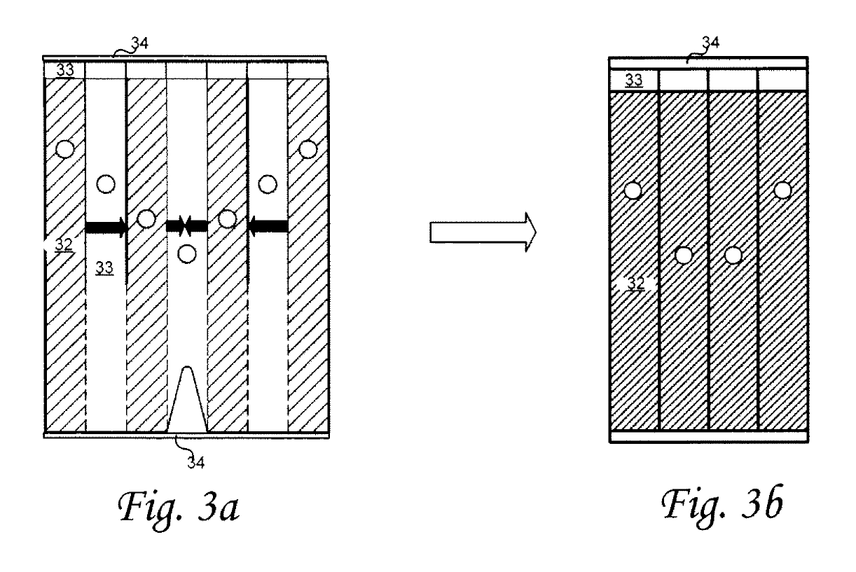

FIGS. 3a and 3b illustrate a top down view of an alternative embodiment employing a collapsible aerial platform. FIG. 3a illustrates the collapsible aerial platform in an uncollapsed state, while FIG. 3b illustrates the collapsible aerial platform in a collapsed state. According to some embodiments, the aerial platform system may be designed to “regulate” flight attitude. As discussed herein, the aerial platform may comprise a plurality of helium cells 32 and ram-air cells 33. The ram-air cells 33 disposed between the helium cells 32 may be configured such that they are collapsible. In these embodiments, collapsing the aerial platform reduces the aerofoil surface area and, accordingly, reduces the aerial platform's lift in windy conditions. Recovery from a deployed state may be easier in these embodiments because the total lift is reduced after collapsing, particularly in embodiments employing a hand winch for the aerial platform deployment and recovery. These embodiments may utilize a second winch to collapse the aerial platform. For example, cords or line may be threaded through portions 34. These cords may be coupled to the vehicle allowing a user on the ground to collapse the aerial platform by drawing on the cords. The drawing may be performed using, for example, a powered winch, a hand winch, or by hand. In further embodiments, as discussed herein, the helium cells 32 may be configured to be partially inflatable, or to serve as ram-air cells when uninflated. In these embodiments, the collapsible nature of the aerial platform allows the user to provide a smaller ram-air parafoil in conditions of very high wind, for example, as in an extreme environment scientific survey.

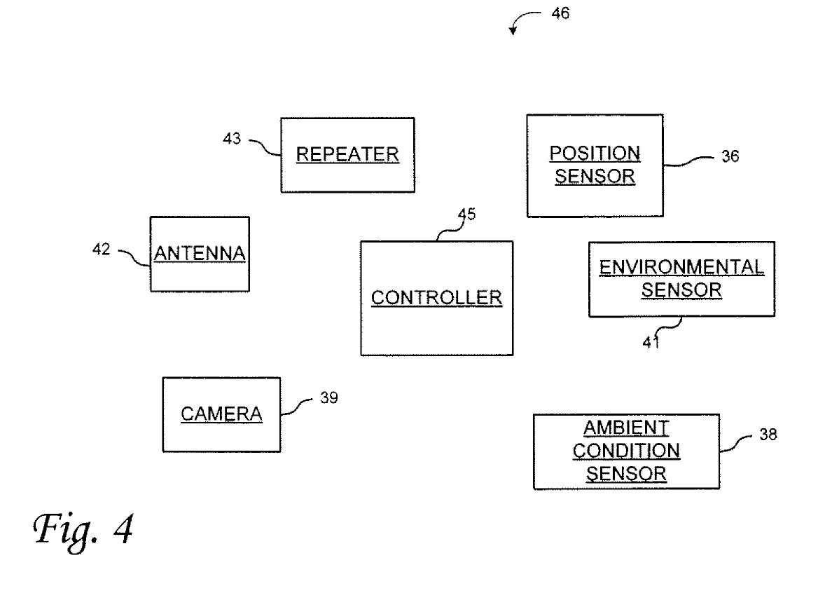

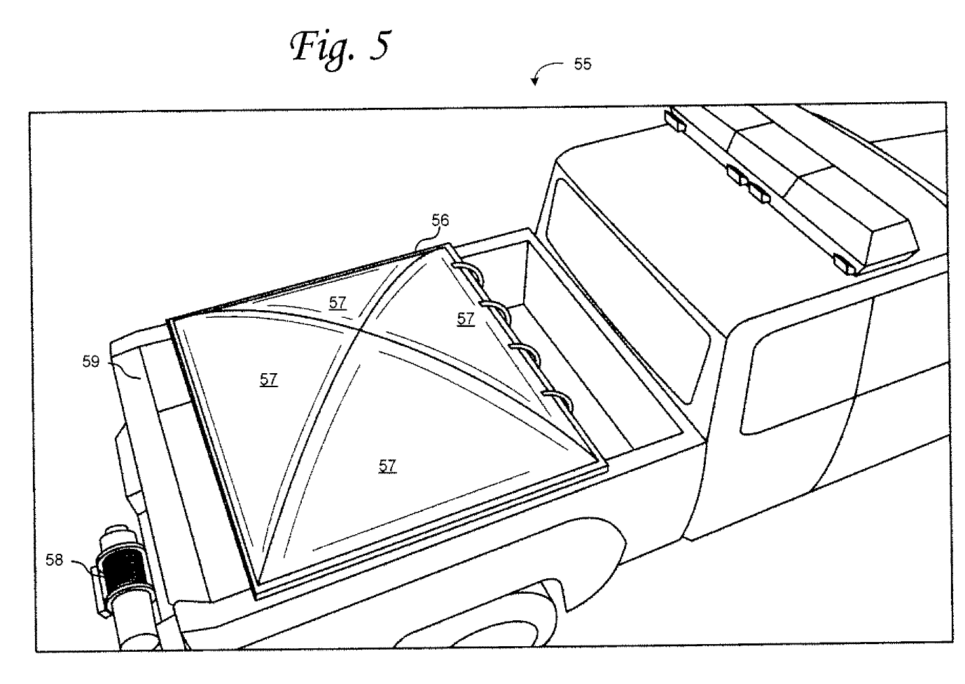

FIG. 4 depicts a functional block diagram illustrating an exemplary payload 46. Payload 46 may comprise a control module 45 in communication with a plurality of different devices. For example, control module 45 may be connected to antenna 42 to enable communications with a base. In some examples, payload 46 may be remotely controlled using antenna 42 and control module 45. In such an example, control module 45 may be programmed to enable a base user to have access to the payload devices 46. In other examples, control module 45 may be programmed to implement some routines autonomously. In these examples, antenna 42 may further serve to allow a base to provide the control module 45 with instructions and for control module 45 to report data back to the base.

In further examples, payload 46 may also comprise a repeater or communications relay 43. Repeater 43 may comprise, for example, an analog or digital radio repeater. In some embodiments, repeater 43 may be used in payloads configured to be used in first responder or disaster relief efforts. In such an example, a plurality of vehicles with aerial platform deployment systems may be positioned at various locations throughout a disaster area. The plurality of vehicles may then deploy their aerial platforms, thus allowing a grid of communications repeaters to be deployed. This grid of communications repeaters may be used to supplement or circumvent a land based communications system, which may be damaged during the disaster or its aftermath.

In other examples, payload 46 may comprise a camera 39 coupled to the control module 45. Camera 39 may be chosen based on desired function. For example, in instances where the aerial platform system will be used in first responder events or aerial surveillance, the camera 39 may comprise an infrared video camera to assist in rescue efforts or fugitive capture. Alternatively, in nature surveillance uses, an infrared camera may assist in animal tracking and population surveying. In other examples, camera 39 may comprise a standard or high-definition video camera. For example, a video camera may be used in traffic or crowd management. Camera 39 may also comprise a still photographic camera, for example for use in aerial photography, roof inspections, and monitoring uses. Control module 45 may be configured to control the camera or cameras via a remote command sent from a base, or it may control the camera itself during execution of an autonomous routine. In some examples, control module 45 may be configured to transmit video or camera images via antenna 42. In further examples, control module 45 may be configured to store video or camera images in an on-board storage medium.

In further examples, payload 46 may further comprise an environmental sensor module 41 coupled to the control module 45. An environmental sensor module 41 might be included in the payload 46 for applications such as, construction site monitoring, environmental clean up monitoring, medium altitude atmospheric imaging, and aerial research surveillance. Environmental sensor module 41 might include, for example, a hyperspectral imaging system for soil monitoring, a radiation sensor, or a chemical sensor for air quality measurements. The environmental sensor module 41 may be coupled to the control module 45. The control module 45 may be configured to control the sensors comprising the environmental sensor module 41 based on commands from the base, or autonomously. The controller 45 may be further configured to transmit received sensor data to the base using antenna 42, or may be configured to store received sensor data in an on-board storage medium.

In some embodiments, payload 46 may further comprise a condition sensor module 38 coupled to the control module 45. Condition sensor module 38 may be configured to provide data about the operating conditions and immediate environmental conditions of the aerial platform and payload. For example, condition sensor module 38 may comprise an accelerometer. Accelerometer data may indicate whether wind conditions may place the payload or aerial platform system in danger. In a further example, condition sensor module 38 may comprise a thermometer or barometer to indicate sudden and severe changes in weather. During an emergency or severe conditions, the control module 45 may be configured to suspend payload operations, control the winch to return the aerial platform to the ground, or to emergency vent helium to return the aerial platform to the ground.

Payload 46 may further comprise a position sensor module 36 coupled to the control module 45. For example, position sensor module 36 may comprise a global positioning system (GPS) unit. The GPS unit might be used in a surveying application to provide accurate location measurements. In other examples, position sensor module 36 may comprise orientation sensors such as compasses and gyroscopes. In these examples, the control module 45 may utilize positioning data provided by the position sensor module 36 to orient itself. For example, in an autonomous application, the control module 45 may utilize the positioning data to assist in proper orientation of the camera or cameras. As a further example, the control module 45 may be provided with instructions to monitor a predetermined area for a predetermined time. Due to wind conditions, the aerial platform may not be stable throughout the predetermined time. The control module 45 may therefore use data from the GPS sensor and data from the positioning data to determine and orient itself to locate and monitor the predetermined area.

FIG. 5 depicts an example non-deployed aerial platform system disposed in the back of a vehicle 59. An aerial platform containment apparatus 56 is configured to contain a deflated aerial platform while not in use. In the illustrated example, aerial platform containment apparatus 56 comprises four panels 57. In some embodiments, the panels 57 may be composed of a lightweight material to reduce total system weight. For example, the panels 57 may be composed of a thin polycarbonate panel. In some examples, the panels 57 may be configured to open by hinging along the bottom seam. In other examples, the panels 57 may be configured to be separately removable.

The example aerial platform system 55 further comprises a winch 58 coupled to the rear of the vehicle 59. The winch 58 may be configured to allow for the controlled deployment and recovery of the aerial platform system from and to the containment apparatus 56. In some embodiments the winch 58 may comprise, for example a plastic cord winder, a manual winch, or an electric-hydraulic winch with a line leveler. Examples utilizing an electric winch can operate from generators, line power and batteries as needed according to the application. In a particular example, the winch 58 comprises an electric-hydraulic winch configured to spool at least 700′ of line for the deployment and recovery of an aerial platform that can reach up to at least 500′.

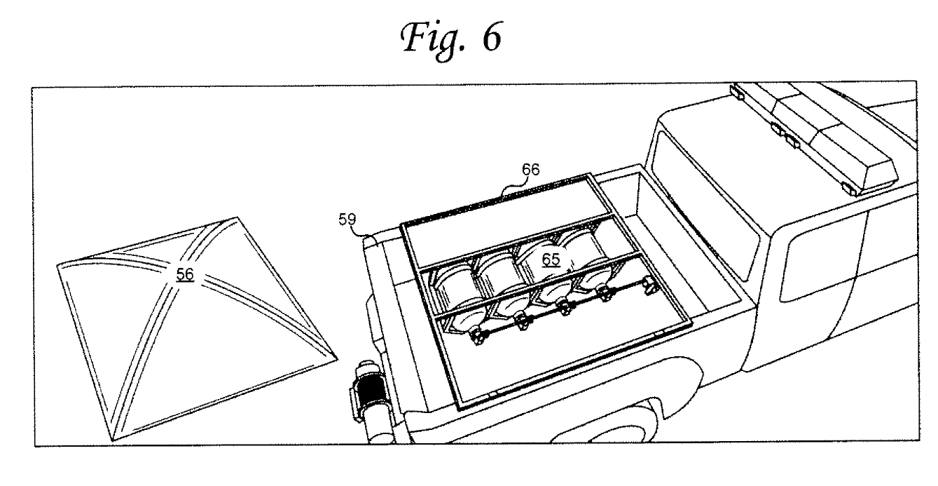

FIG. 6 depicts a non-deployed aerial platform system, illustrating an example placement of an inflation system. Aerial platform containment apparatus 56 is depicted on the ground next to vehicle 59 to illustrate the placement of the inflation system 65. In some examples, inflation system 65 comprises a frame 66 configured to attach to the walls of the bed of the vehicle 59. In the illustrated examples, the aerial platform containment apparatus 56 is dimensioned so that when attached to the frame 66 it completely covers the inflation system 65, as is illustrated in FIG. 5. In further examples, aerial platform containment apparatus 56 may be configured such that it is deployable from the ground. For example, aerial platform containment system 56 may have a mat integral with the bottom of the system, to protect the aerial platform while on the ground. The aerial platform containment system 56 may also have stake down portions, which allow the aerial platform to be staked down to the ground, thus allowing the aerial platform to be deployed from and secured to the ground. This configuration allows the vehicle 59 to leave the vicinity, for example, to refill the helium tanks to lengthen the time the aerial platform may remain deployed.

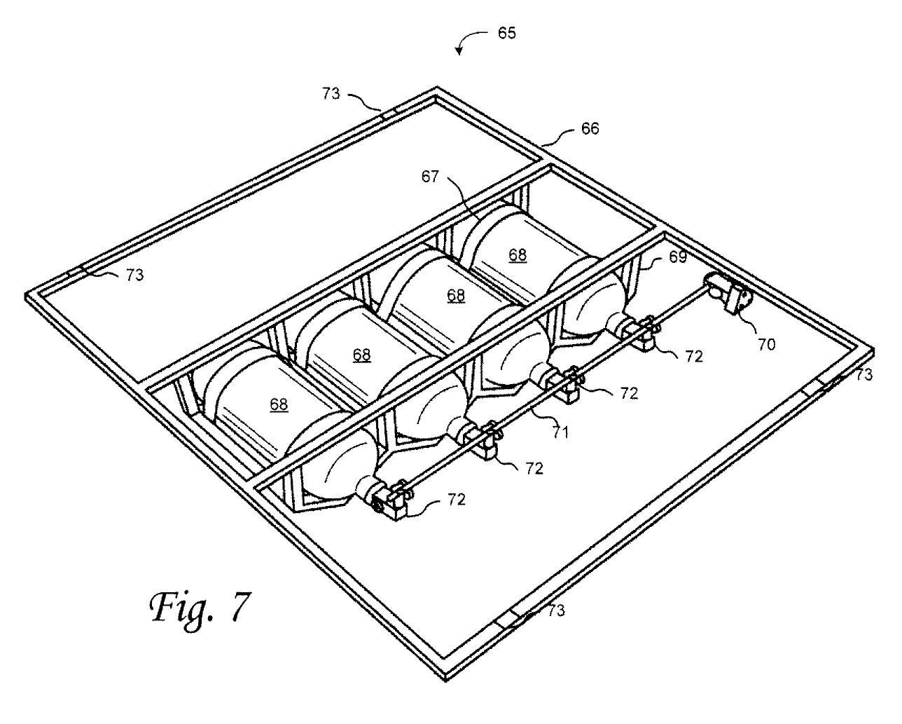

FIG. 7 depicts an example inflation system 65. Inflation system 65 may comprise a frame 66, having a width 74 and a length 75. In some examples, frame 66 may be composed of a lightweight yet rigid material, such as aluminum, to reduce total system weight. In some embodiments, the means for transporting and delivering the aerial platform may comprise a frame 66 that is dimensioned and configured to be attached to the walls of a vehicle bed. In particular, the width 74 of the frame 66 may be large enough that the system can rest on the walls of a truck or on a vehicle bed. In a particular example, width 74 is 4′6″. Length 75 may be chosen long enough to contain the gas cylinders 68, yet short enough to fit a variety of different vehicles. In a particular example, a length 75 of 4′ allows the system to accommodate four gas cylinders and fit into both long and short truck beds. In some examples, frame 66 may further comprise transport handles 73. Transport handles 73 may be integrally formed, welded, bolted, or otherwise affixed to the frame 66. Transport handles 73 allow the frame 66 to be disposed within or removed from a vehicle.

Frame 66 further comprises a frame portion 69 configured to receive a gas cylinder 68. In the illustrated example, gas cylinders 68 are held in place in receiving frame portion 69 by straps 67. Straps 67 may be composed of, for example, nylon webbing. Gas cylinders 68 hold the gas used for inflating the aerial platform. In a particular example, helium gas is used. In some examples, gas cylinders are composed of a lightweight and high-strength material. In a particular example, the gas cylinders are carbon fiber gas cylinders, which in some instances, allows 50% more gas to be stored than in a conventional equal-sized metal cylinder. The number of gas cylinders used may be chosen based on aerial platform volume requirements and gas cylinder containment volumes. Gas cylinders 68 may be connected to gas pipe 71 using valves 72. Gas pipe 71 may deliver gas to the aerial platform using a helium release manifold 70. In some embodiments, the inflation system 65 may be further configured to recycle gas that remains in the aerial platform after use. For example, the winch may be configured to lower the aerial platform near to the ground to enable access. The inflation system 65 may be configured to remove the gas from the aerial platform, for example, using a Haskel pump. Valves 72, gas pipe 71 and helium release manifold 70 may be further configured to receive incoming gas, and to transport gas back into the cylinders 68.

Alternatively, gas cylinders 68 may be coupled together in a clustered arrangement, for example through the use of straps. Additionally, aerial platform containment system 56 may be configured such that it also has a smaller profile, for example through rolling. In this configuration, the aerial platform deployment system may be transported in a more compact form. For example, the aerial platform deployment system may be transported using a dolly or a small trailer, instead of using the back of a vehicle.

According to further embodiments of the invention, another means of transportation and delivering the aerial platform may comprise an apparatus comprising a small container that can be fashioned to be carried in a backpack configured serve as an integrated backpack system. Alternatively, the backpack may be dimensioned such that when attached to an appropriate small container, the inflation system, tether, harnesses, gas containment systems, payload, and other associated components are completely stowed and ready for rapid inflation and deployment.

According to other embodiments, the means of transportation and delivering the aerial platform is an apparatus comprising a small container that can be fashioned to be transported on small, open air, four-wheeled vehicles by incorporating mechanical towing fixtures onto the vehicle.

According to additional embodiments, the means of transportation and delivering the aerial platform is an apparatus comprising a leave-behind system including a universal attachment fixture for wheel axles, fire hydrants, poles, concrete blocks, and aircraft tie-down anchoring fixtures. The leave-behind system may be dimensioned such that when attached to an appropriate attachment point, the inflation system, tether, harnesses, gas containment systems, payload, and other associated components are completely stowed and ready for rapid inflation and deployment.

According to further embodiments, the means of transportation and delivering the aerial platform is an apparatus comprising a protective and transportable structure, such as a trailer having a clamshell opening to permit the aerial platform system operator to leave the system either partially or fully inflated. The trailer may include a modification to the roof to facilitate the clamshell opening of the trailer roof for launching, operating, recovering, stowing and transporting the aerial platform system.

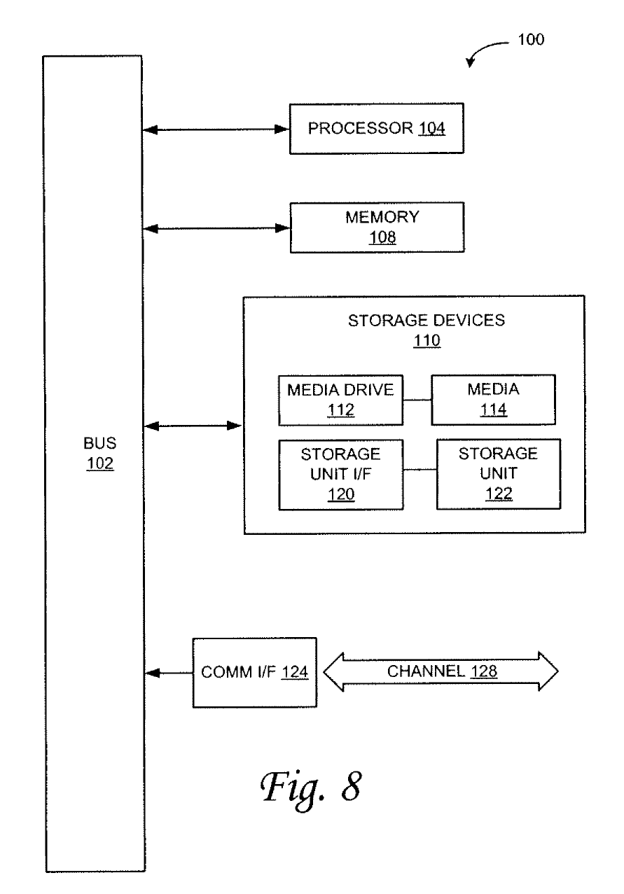

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 8. Various embodiments are described in terms of this example-computing module 100. After reading this description, it will become apparent to a person skilled in the relevant art how to implement the invention using other computing modules or architectures.

Referring now to FIG. 8, computing module 100 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 100 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 100 might include, for example, one or more processors, controllers, control modules, or other processing devices, such as a processor 104. Processor 104 might be implemented using a general-purpose or special-purpose processing engine such as, for example, a microprocessor, controller, or other control logic. In the example illustrated in FIG. 8, processor 104 is connected to a bus 102, although any communication medium can be used to facilitate interaction with other components of computing module 100 or to communicate externally.

Computing module 100 might also include one or more memory modules, simply referred to herein as main memory 108. For example, preferably random access memory (RAM) or other dynamic memory might be used for storing information and instructions to be executed by processor 104. Main memory 108 might also be used for storing temporary variables or other intermediate information during execution of instructions to be executed by processor 104. Computing module 100 might likewise include a read only memory (“ROM”) or other static storage device coupled to bus 102 for storing static information and instructions for processor 104.

The computing module 100 might also include one or more various forms of information storage mechanism 110, which might include, for example, a media drive 112 and a storage unit interface 120. The media drive 112 might include a drive or other mechanism to support fixed or removable storage media 114. For example, a hard disk drive, a floppy disk drive, a magnetic tape drive, an optical disk drive, a CD or DVD drive (R or RW), or other removable or fixed media drive might be provided. Accordingly, storage media 114 might include, for example, a hard disk, a floppy disk, magnetic tape, cartridge, optical disk, a CD or DVD, or other fixed or removable medium that is read by, written to or accessed by media drive 112. As these examples illustrate, the storage media 114 can include a computer usable storage medium having stored therein computer software or data.

In alternative embodiments, information storage mechanism 110 might include other similar instrumentalities for allowing computer programs or other instructions or data to be loaded into computing module 100. Such instrumentalities might include, for example, a fixed or removable storage unit 122 and an interface 120. Examples of such storage units 122 and interfaces 120 can include a program cartridge and cartridge interface, a removable memory (for example, a flash memory or other removable memory module) and memory slot, a PCMCIA slot and card, and other fixed or removable storage units 122 and interfaces 120 that allow software and data to be transferred from the storage unit 122 to computing module 100.

Computing module 100 might also include a communications interface 124. Communications interface 124 might be used to allow software and data to be transferred between computing module 100 and external devices. Examples of communications interface 124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 124 might typically be carried on signals, which can be electronic, electromagnetic (which includes optical) or other signals capable of being exchanged by a given communications interface 124. These signals might be provided to communications interface 124 via a channel 128. This channel 128 might carry signals and might be implemented using a wired or wireless communication medium. These signals can deliver the software and data from memory or other storage medium in one computing system to memory or other storage medium in computing system 100. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 108, storage unit 120, and media 114. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 100 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, comprising:
providing an aerial platform having an outer shell;
disposing a gas containment system within the outer shell;
attaching the aerial platform to an object using a tether system; and
inflating the aerial platform and lifting a payload;
wherein the aerial platform is configured such that it may be completely collapsed when deployed.

2. The method of claim 1, further comprising providing a rapid deflation device to facilitate rapid deflation of the gas containment system in the event of line separation.

3. The method of claim 2, wherein the rapid deflation device comprises a microcontroller, power circuit, logic circuit and wiring harness directly affixed to the gas containment system such that, in the event of line breakage, power is applied to the wiring harness and exposed wires to create vent holes in the gas containment system for gas to rapidly escape.

4. The method of claim 1, wherein the object comprises a means for transporting the system.

5. The method of claim 4, wherein the means for transporting the system comprises a vehicle.

5. The method of claim 1, wherein the object comprises a light post, fire hydrant, or wheel axle.

6. The method of claim 1, further comprising providing a torque stabilization system disposed along an aft section of the outer shell surface of the aerial platform to provide directional stability along the longitudinal axes of the aerial platform during flight.

7. The method of claim 6, wherein the torque stabilization system comprises a top rudder stabilization shroud, a bottom rudder stabilization shroud, a top vertical stabilizer, and a bottom vertical stabilizer.

8. The method of claim 1, wherein the outer shell of the aerial platform provides an aerodynamic shape to effect desired flight performance characteristics.

9. The method of claim 1, wherein the gas containment system comprises one or more inflatable gas bladder inserts contained by the aerodynamically shaped outer shell, thereby providing the combination of an aerodynamic lifting body and a lifting gas-filled aerial platform.

10. The method of claim 1, wherein the tether system comprises one or more bridle lines and a tether.

11. The method of claim 10, wherein the one or more bridle lines attach the aerial platform to the tether, which attaches the aerial platform to a system power supply.

12. The method of claim 11, wherein the tether and one or more bridle lines include cables for transmitting power to the aerial platform from the system power supply.

13. The method of claim 10, wherein the tether and one or more bridle lines are composed of electrically conductive materials to provide power to the aerial platform system

14. The method of claim 1, further comprising providing an onboard flight control system to enable the aerial platform system to maintain and achieve a stationary position in no wind, low wind, gusty wind and high wind environments.

15. The method of claim 1, further comprising providing an onboard monitoring system to provide for capturing, receiving, storing and publishing data collected by one or more onboard sensors.

16. The method of claim 15, wherein the one or more onboard sensors are selected from the group consisting of: a horizontal attitude sensor; an altitude sensor; an external ambient environmental conditions sensor; a gas chamber volume sensor; and a tether force or tension sensor.

17. The method of claim 16, further comprising providing a means for transmitting and receiving the captured, stored, retrieved and published data to provide an automated training and support system.

18. The method of claim 1, wherein the payload comprises a single payload or a plurality of payloads comprising a variety of articles or devices.

19. The method of claim 1, wherein the payload carries a communication repeater such as a digital or analog signal repeater for use in an emergency where local communications have been impaired.

20. The method of claim 1, wherein the payload carries surveillance equipment for use in police emergencies such as car chases, crime scene investigations, and amber alerts.
